(19) United States
(12) Patent Application Publication
(10) Pub. No.: US 2024/0022110 A1
(43) Pub. Date: Jan. 18, 2024

(54) ELECTRONICS IN HIERARCHICAL CIRCUIT ARCHITECTURES THAT CONTROL HIGH VOLTAGES AND PROVIDE CYBER INTRUSION DETECTIONS

(71) Applicant: UT-Battelle, LLC, Oak Ridge, TN (US)

(72) Inventors: Suman Debnath, Oak Ridge, TN (US); Phani Ratna Vanamali Marthi, Oak Ridge, TN (US); Rafal P. Wojda, Oak Ridge, TN (US); Qianxue Xia, Oak Ridge, TN (US); Maryam Saeedifard, Oak Ridge, TN (US)

(73) Assignee: UT-Battelle, LLC, Oak Ridge, TN (US)

(21) Appl. No.: 18/219,860

(22) Filed: Jul. 10, 2023

Related U.S. Application Data
(60) Provisional application No. 63/389,887, filed on Jul. 16, 2022.

(51) Int. Cl. H02J 13/00; H02J 3/38; G06F 21/55; G06N 20/00

(52) U.S. Cl. CPC H02J 13/00002; H02J 3/381; G06F 21/554; G06N 20/00; H02J 2300/22; H02J 2203/10; H02J 2203/20; G06F 2221/034

(57) ABSTRACT

An autonomous reconfigurable system has arms terminating at inductors. The inductors are connected to a photovoltaic submodule, an energy storage system submodule, and a submodule that source a direct current voltage and an alternating current voltage. A central processor controller determines arm modulation indices and issues reference power commands for the submodules and detects cyber-attacks and/or bad data threats. A field programmable gate array disaggregates monitored variables monitored from each arm. Multiple digital signal processor controllers communicate with each of the each of the submodules.

### PRIORITY CLAIM

This application claims priority to U.S. Provisional Patent Application No. 63/389,887, titled “Large-Scale Power Electronics—Circuit Architecture and Hierarchical Architecture for Control and Cyber Intrusion Detection”, which was filed on Jul. 16, 2022 that is herein incorporated by reference.

### STATEMENT REGARDING FEDERALLY SPONSORED RESEARCH AND DEVELOPMENT

These inventions were made with United States government support under Contract No. DE-AC05-00OR22725 awarded by the United States Department of Energy. The United States government has certain rights in the inventions.

### TECHNICAL FIELD

This disclosure relates to power electronics and more specifically to a hierarchical architecture that generates and provides power to the power grid and provides cyber intrusion detections.

### RELATED ART

The power grid is an interconnected network that delivers electricity to users. It includes power stations that generate power, electrical substations that step up voltages, electrical power transmission lines that transport power, and electric power distribution stations that step down voltages.

In the contiguous United States, there are three power grids. They are the Eastern power grid, the Western power grid, and the Texas power grid. The vastness of these power grids make them vulnerable to cyclical demand and cyber-attacks.

Decarbonizing the power gird and generating energy from renewable sources also poses challenges to the power grid. The current integration of discrete renewable power sources and energy storage feeding the power grid does not provide a consistent and reliable source or distribution to where it is needed.

### DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is an autonomous reconfigurable system.

FIG. 2 is an autonomous reconfigurable system circuit.

FIG. 3 is a hierarchical control system of the autonomous reconfigurable system.

FIG. 4 is a second hierarchical control system of the autonomous reconfigurable system that detects cybersecurity threats.

FIG. 5 is a process that detects cybersecurity threats.

FIG. 6 is a nonlinear autoregressive network with exogenous inputs.

FIG. 7 is a process flow that constructs and evaluates artificial intelligence models.

FIG. 8 is a distributed simulation of an exemplary autonomous reconfigurable system.

FIG. 9 is a comparison of the phase in the upper-arm currents generated from a model estimate and measured electromagnetic transient models showing: (a) step changes in P_{ac-ref} from 0 MW to 30 MW and P_{dc-ref} from 0 MW to −100 MW, (b) step changes in P_{ac-ref} from 30 MW to 100 MW and P_{dc-ref} from −100 MW to 0 MW, and (c) step changes in P_{ac-ref} from 100 MW to 170 MW and P_{dc-ref}, from 0 MW to 200 MW.

FIG. 10 is a comparison of the phase in the upper-arm's summation of the submodule capacitor voltages generated from a model estimate and a measured electromagnetic transient model simulations showing: (a) step changes in P_{ac-ref} from 0 MW to 30 MW and P_{dc-ref} from 0 MW to −100 MW, (b) step changes in in P_{ac-ref} from 30 MW to 100 MW and P_{dc-ref} from −100 MW to 0 MW, and (c) step changes in P_{ac-ref} from 100 MW to 170 MW and P_{dc-ref} from 0 MW to 200 MW.

FIG. 11 is a comparison of the phase in an upper-arm's summation of an absolute value of the difference between the estimated submodule capacitor voltages and measured electromagnetic transient model simulations showing: (a) step changes in P_{ac-ref} from 0 Mega Watt (MW) to 30 MW and P_{dc-ref} from 0 MW to −100 MW, (b) step change in in P_{ac-ref} from 30 MW to 100 MW and P_{dc-ref} from −100 MW to 0 MW, and (c) step change in P_{ac-ref} from 100 MW to 170 MW and P_{dc-ref} from 0 MW to 200 MW.

FIG. 12 is an alternative autonomous reconfigurable system.

### DETAILED DESCRIPTION

An autonomous reconfigurable process and/or system (referred to as a system(s)) increases the reliability of the power grid and reduces power outages. The system increases the capacity of the power grid, provides renewable resources to respond to unexpected demands, and allows for maintenance by allowing other power sources to be taken off-line for testing, monitoring, and repairs without disrupting service.

The systems' hierarchical controller monitors aggregate power flow through the power grid in real time, ensuring a constant and consistent supply. The subsidiary controllers that comprise the systems' hierarchical controller monitor each branch of the system in real time while mitigating cyber intrusions and threats using artificial intelligence.

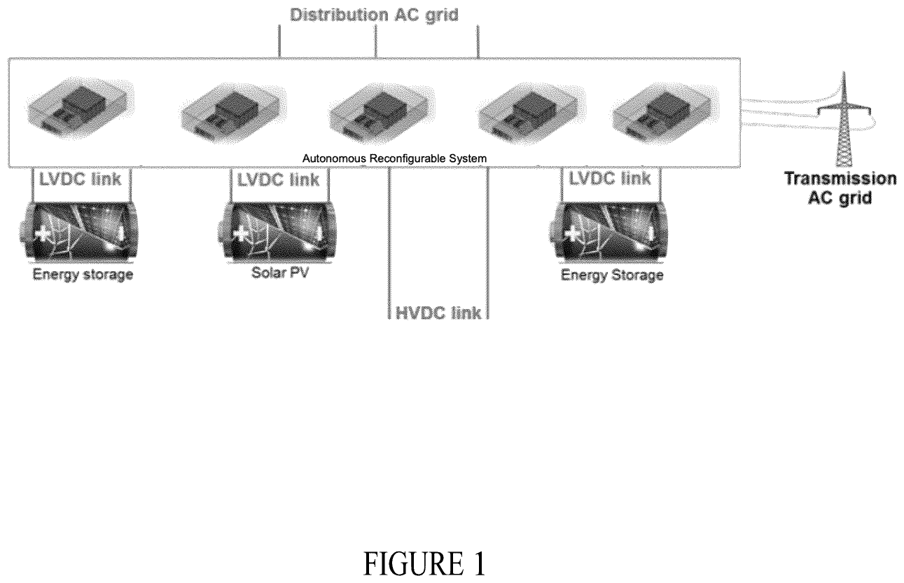

The autonomous reconfigurable systems of FIG. 1 interface and/or integrate centralized low voltage (LV) direct power sources (LV_{dc}) such as energy storage systems (ESS) and solar photovoltaic (Solar PV) sources at a utility scale into a high-voltage (HV) and/or medium voltage (MV) direct current (HV_{dc} and/or MV_{dc}) and/or alternating current (HV_{ac} and/or MV_{ac}) power stations. In alternating current-grid systems, voltage, current, and frequency are monitored to ensure the voltages are synchronous to maintain stability, dependability, and reliability. In direct current-grid systems, voltage and current levels are primarily monitored as there are fewer reactive interactions. In this disclosure, a utility scale refers to an electrical plant or system that has a name-plate capacity (e.g., a maximum rated output) of about five million watts or five megawatt (MW). High voltage refers to about hundreds of volts to about thousands of volts and medium voltage generally refers to a range between about 1 kV and about 52 kV.

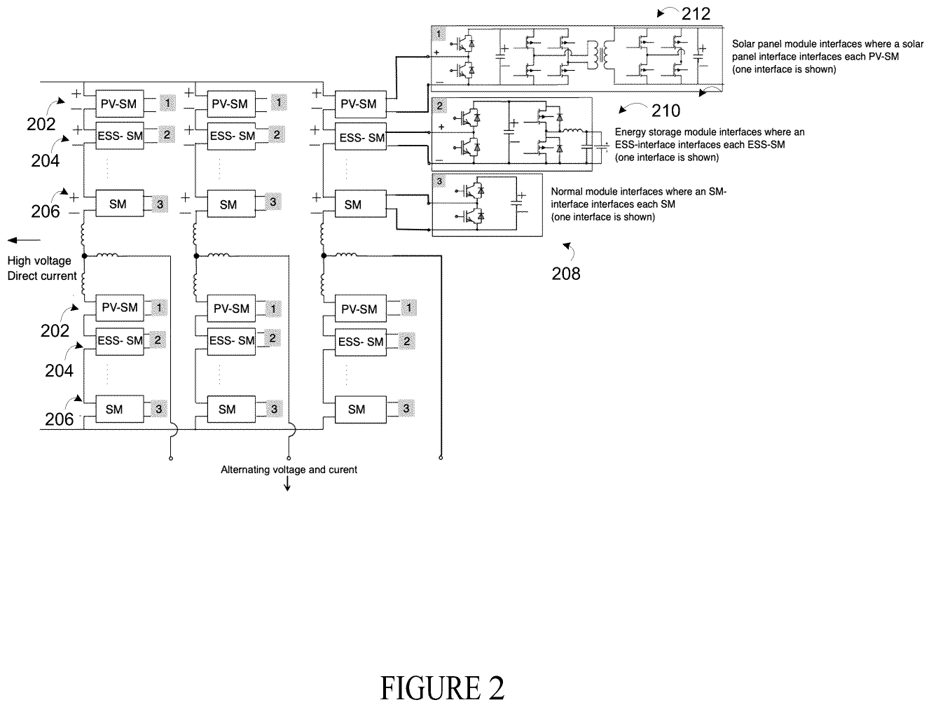

In FIG. 2, the autonomous reconfigurable system connects to a high-level and/or mid-level direct current power grid system at a common mode and connects to an alternating current power grid at a differential mode output. The system architecture includes multiple arms with each arm comprising multiple submodules connected in series that terminates at an inductor to form a three port circuit at a common node. The series connected submodules include photovoltaic submodules (PV-SMs) 202, energy storage system submodules (ESS-SMs) 204, and submodules (SMs) 206. Each of the submodules 202, 204, and 206 include or interface a low switching frequency device or a modular converter 208 that comprises two switches (e.g., two insulated-gate bipolar transistors (IGBT), referred to at T1 and T2, respectively) configured in a half-bridge topology that connects to a capacitor across its output. The output of the modular converter 208 is expressed by:

$$Vterminal node = \{ \begin{matrix}Vc & if T 1 is ‘ ON ’ ; T 2 is ‘ OFF ’ \\ 0 & if T 1 is ‘ OFF ’ ; T 2 is ‘ ON ’\end{matrix} \qquad ( 1 )$$

V_{c} represents the magnitude of the instantaneous capacitor voltage. The modular converter 208 (also referred to as the modular front-end) is ‘ON’ when V_{terminal-node}=V_{c}; it is ‘OFF’ when V_{terminal-node}=0. The front-end half-bridges produce a wide range of medium and/or high grid utility voltage that meet the Institute of Electrical and Electronics Engineers (IEEE) 519 standards, which do not require a high switching frequency. The IEEE 519 standards define the voltage and current harmonics distortion criteria for the design of electrical systems.

In FIG. 2, the modular front-end converters source a non-isolated converter in a multi-stage converter shown as the energy storage module 210 comprising and/or interfacing the energy storage system submodules 204. These multi-stage converter modules 210 do not include devices that transfer energy from one circuit to another by electromagnetic induction (e.g., transformerless) and do not require a physical separation between the output circuit and the energy storage system sources. The multi-stage converter module 210 (e.g., the modular converters 208 connected to the non-isolated converters) is smaller, lighter, and more efficient than other converters as no transformer losses occur. The non-isolated converters use silicon carbide (SiC) metal-oxide-semiconductor field-effect transistors (MOSFETs) that connect to a series resonant circuit at its bridge to provide voltage magnification by its series connections. The silicon carbide metal-oxide-semiconductor field-effect transistors enable higher switching frequencies and reduce the size of components. Multi-phase devices that have no moving parts and transfer energy from one circuit to another circuit by electromagnetic induction are used in the solar panel module 212 interfacing the photovoltaic submodules 202 in FIG. 2. In these modules, energy is transferred without a change in frequency, but usually with a change in voltage and current.

A second multi-state converter shown as the solar panel module 212 that is part of each of the photovoltaic submodules 202 cascades a modular inverter to the first H-bridge that sources an isolation transformer. The isolation transformer requires little maintenance because of its durable construction. The secondary of the isolation transformer is connected to a second H-bridge forming a dual active bridge that sources the photovoltaic power and provides the electrical isolation between sources and loads. In FIG. 2, the H-bridges comprise silicon carbide metal-oxide-semiconductor field-effect transistors.

In alternative autonomous reconfigurable systems, the solar panel modules 212 and/or energy storage modules 210 are modified by adding and/or substituting a direct current to alternating current converter, e.g., instead of a dc-dc converter, to integrate other power sources such as wind turbines, for example, to the power grid. Similarly, electric vehicle chargers are alternatively connected through a similar dc-dc converter that are part of the solar panel modules 212 in some autonomous reconfigurable systems.

In FIG. 2 the combination of fast switching silicon carbide metal-oxide-semiconductor field-effect transistors used in some or all of the modules 208-212 and multilevel arm voltages, with the communication bandwidth and the high-performance computing capabilities of the systems' hierarchical controller (described below), provide real time dynamic responses. The silicon carbide metal-oxide-semiconductor field-effect transistors are unipolar devices that demonstrate a low on-state voltage drop, low terminal capacitance, and dramatically lower switching losses when compared to similarly rated silicon insulated gate bipolar transistors. The combination moves high-speed unipolar devices into higher voltage classes than silicon devices. They are efficient, have high power densities, maintain high performance, and lower the cost of the converters and inverters. The combination enables the system to bring its ancillary power sources on line quickly while maintaining its high reconfigurability. Other configurations of the system includes different and/or additional renewable sources in series connections with the disclosed submodules 202-206 in each arm further reduces the cost of renewable energy compared to decentralized forms of energy production or distributed generation forms produced “off the grid”.

Benefits of the renewable source integration include mitigating the low inertia phenomena common to solar power plants. During alternating grid events that lead to large frequency and voltage variations, power from the embedded energy storages, solar panels, and/or dc links also emulate a synchronous generator which actively dampens frequency and voltage variations, and decreases the likelihood of brownouts and/or shutdowns. The systems also mitigate alternating current transmission bottlenecks by providing effective damping control and additional dynamic voltage support to the alternating current power grid, which also improves the transfer capability of congested alternating current transmission lines. The systems support operational stability through disturbance control that dampens the detected oscillations that occur in asynchronous power grids.

Some autonomous reconfigurable systems also provide direct power sources to electric power distribution stations and/or load centers. These systems link direct current sources directly into large urban areas to overcome issues associated with distributed generation. The systems integrate renewable sources of energy into weak and vulnerable regional power grids and/or the national grid. The autonomous reconfigurable systems also harmonize the operation of multiple electrical sources. Unlike the patchwork of discrete power generation, the disclosed autonomous reconfigurable systems execute hierarchical control strategies that include measurements from renewable energy sources such as solar power panels and/or energy storage systems, for example, processed by an integrated control system 302 (e.g., in the form of a hierarchical control system) that minimizes and/or dampens harmonic noise and eliminates the need for competing control systems. Further, the systems' scalability provides the capability to integrate other energy resources including other/different renewable energy sources in a common physical location (e.g., within one plant or within one physical location) and provides connectivity to different alternating current and direct current system platforms.

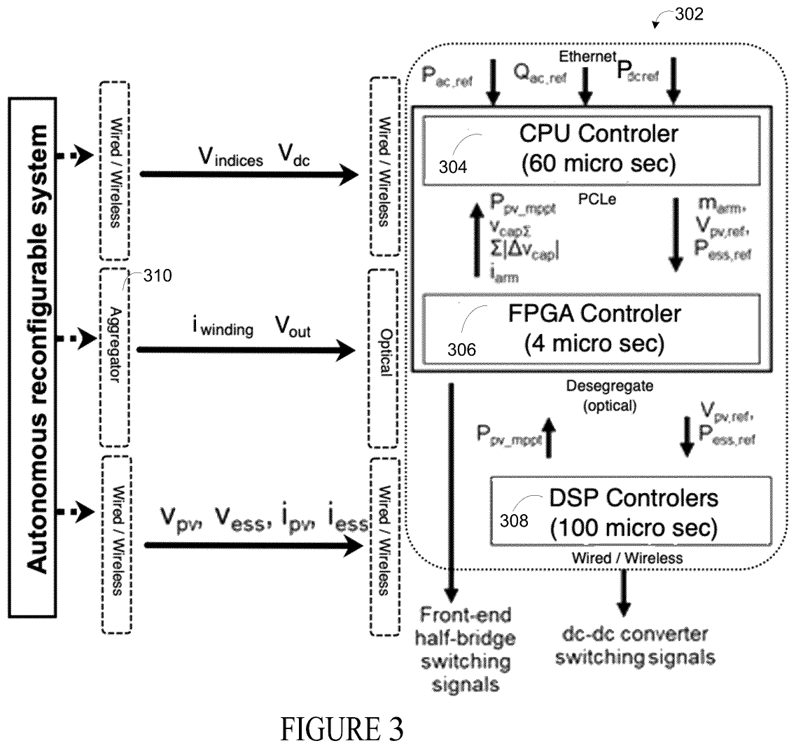

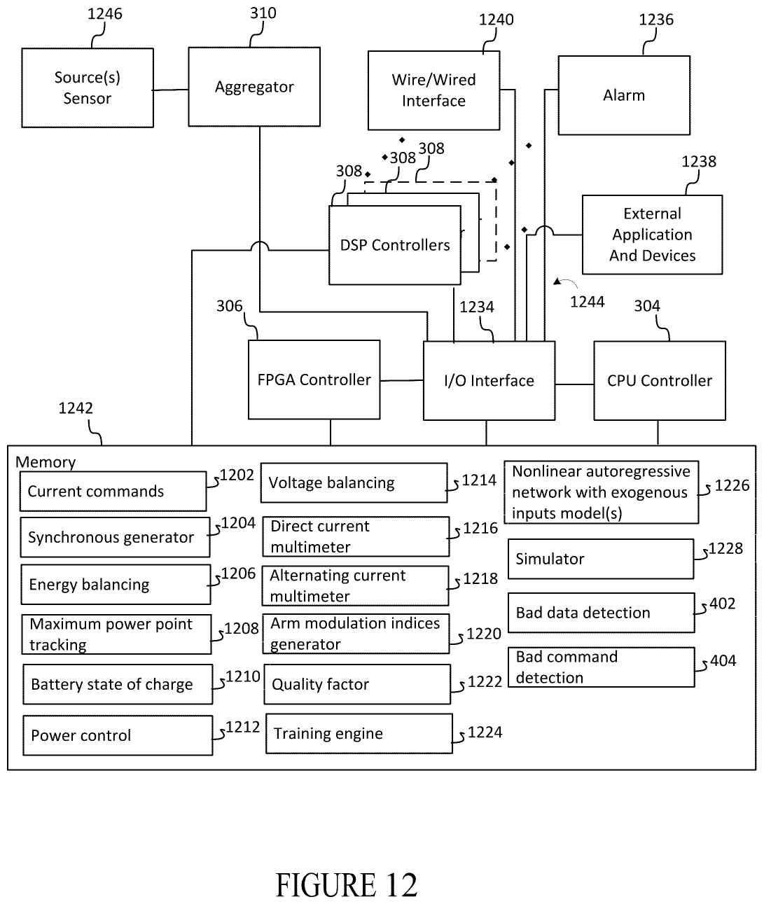

FIG. 3 is an exemplary integrated control system 302 of the autonomous reconfigurable system through an aggregator 310 that collects data from one or more sources such as sensors, for example. The exemplary integrated control system 302 integrates photovoltaic and energy storage systems to high voltage direct current links, medium voltage direct links and/or alternating current links through its management of photovoltaic submodules 202, energy storage system submodules 204, and/or the submodules 206 through a modular and hierarchical controller topology. A central processing unit controller 304 controls the direct current and alternating current side by processing power quality functions 1220, a synchronous generator emulation function 1204, internal energy balancing (e.g., energy balancing control 1206), and control currents (e.g., alternating current and/or direct current, circulating internal currents, etc.) 1202 shown in FIG. 12. The power quality functions 1222 reflects the quality of electrical power produced by the autonomous reconfigurable system, including during abnormal operating conditions through dynamic voltage support for the system. Power quality functions 1222 describe the electric power that drives the electrical load, which allows the load to function properly. The synchronous generator emulation function 1204 is the systems' grid-connected inverter control, which provide inertia and dynamic frequency support for the system. The energy balancing control 1206 ensures that internal energy is balanced in the submodules.

In a use case, the central processing unit (CPU) controller 304 receives power dispatch commands from one or more system operators and/or other sources that include commands related to power transferred to the alternating current side (P_{ac-ref}), power transferred to direct current side (P_{dc-ref}), and reactive power provided to the alternating current side (Q_{ac-ref}). In response, the integrated control system 302 provides voltage and frequency support to the alternating current grid, maintains the power dispatched from the integrated system, controls direct current link voltages and alternating current/direct currents, and provides energy balancing control 1206 between the submodules 202, 204, and 206. The CPU controller 304 responds to a synchronous generator emulation function 1204 and determines arm modulation indices (mₐᵣₘ) and also determines the reference power commands transmitted to the photovoltaic submodules 202 and the energy storage system submodules 204 (P_{pv-ref} and P_{ess-ref}). The reference power commands for the photovoltaic submodules 202 and the energy storage system submodules 204 may depend upon the power dispatch commands, additional power requirements from the power generator (based on the synchronous generation emulation function) of the autonomous reconfigurable system (ΔP and ΔQ), the maximum available photovoltaic power (Pₚᵥ₋ₘₚₚₜ 1208), and/or the energy storage system submodules' rating (P_{ess-rating}). The CPU controller 304 sends the modulation indices of each arm, the referenced photovoltaic power, and the referenced energy storage systems power to a field programmable gate array controller 306.

The CPU controller 304 controls the arms output of the autonomous reconfigurable system as an aggregate to maintain a grid-source and a circuit stability, which means that the CPU controller 304 does not directly control each individual submodule 202-206. The FPGA controller 306 disaggregates the monitored variables and issues commands that maintain the stability in each individual module and submodule through a capacitor voltage balancing 1214.

The field programmable gate array (FPGA) controller 306 sums the capacitor voltages from each arm (ΣV_{cap}) and sums the absolute value of the difference between individual capacitor voltages from the average of the capacitor voltages of the modules in each arm (Σ|ΔV_{cap}|). In FIG. 3, the FPGA controller 306 is programmed to maintain the capacitor voltages balanced across the modules and submodules in each arm based on its module capacitor voltage balancing 1214. The FPGA controller 306 receives the maximum power that can be generated by photovoltaic sources (Pₚᵥ₋ₘₚₚₜ 1208) from each digital signal processor (DSP) controller 308 and transmits a photovoltaic/energy storage system (PV/ESS) power reference (P_{pv-ref}/P_{ess-ref}) to each of the DSP controllers 308. The FPGA controller 306 also generates the switching signals for the front-end half-bridges of all the submodules.

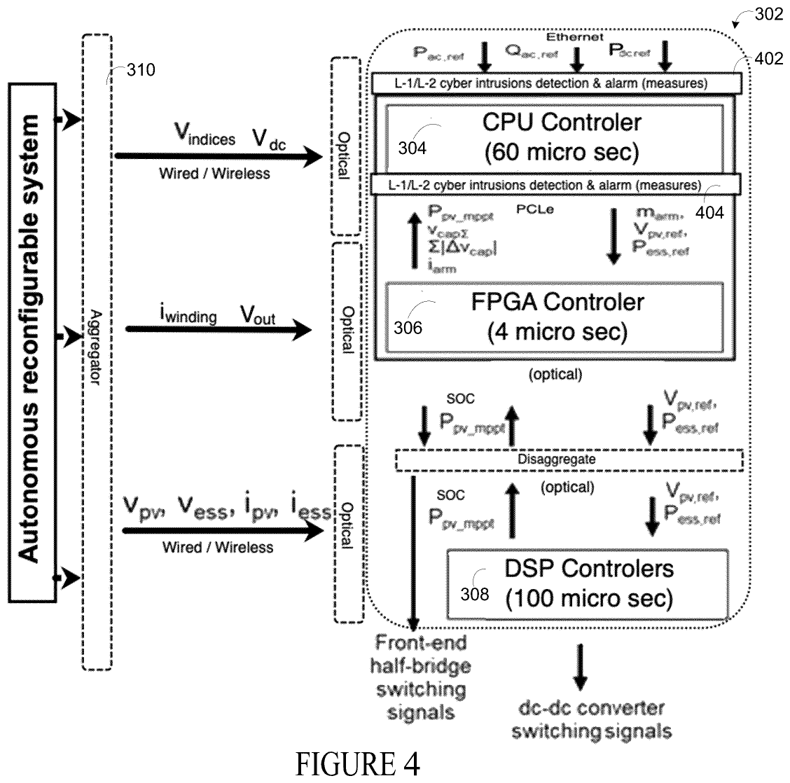

The digital signal processors shown as the DSP controllers 308 in FIGS. 3 and 4 control photovoltaic submodules 202 and energy storage system submodules 204. In other words, each photovoltaic submodule 202 and energy storage system submodule 204 has its own dedicated DSP controller 308 (e.g., in continuity with each arm) that directly controls those submodules.

In photovoltaic submodules 202, the DSP controller 308 identifies the maximum power that can be generated by the photovoltaic sources (Pₚᵥ₋ₘₚₚₜ) and controls the voltage at the terminals of the photovoltaic submodules 202. The DSP controllers 308 also control the inductor current based on the photovoltaic power reference (P_{pv-ref}) transmitted from FPGA controller 306. In the energy storage system submodules 204, each DSP controller 308 determines the state-of-charge (SOC) 1210 of its voltage storage, and controls the power required from the voltage storages and the inductor current based on the energy storage systems power reference (P_{ess-ref}) received from FPGA controller 306. The DSP controller 308 also generates the switching commands for the dc-dc converter switches in the photovoltaic submodules 204 and energy storage system submodules 202 based on the duty cycle ratios that are generated.

FIG. 4 is an exemplary integrated control system that detects cybersecurity command threats and/or a separate corrupt/bad data threats. In FIG. 4, a cyber security intrusion detection system comprising a bad data detection layer 402 pre-processes the inputs to CPU controller 304 and bad command detection layer 404 illustrated at the bottom of the CPU controller 304 screens external and harmful commands. The bad command detection layer 404 detects cyber-intrusions and/or harmful commands. In this disclosure, bad data refers to the data that is inaccurate, inaccessible, poorly compiled, duplicated, has key elements missing and/or modified without authorization, represents bad inferences and/or is irrelevant to the purpose it is intended to be used for and/or processed. In some systems, it is used to identify sensor faults, instrument faults, and/or cyber threats and cyber intrusions.

In some controllers, artificial intelligence (AI) makes bad command and corrupt/bad data detections in response to legacy data, infected operating states and/or internal control states of the system. Based on comparisons, a neural network trained by a training engine 1224, detects, isolates, and/or mediates malicious commands and/or bad data received externally or received from the systems including through its sensors. Some alternative trained neural networks comprise feedforward artificial neural networks that generate neuron nodes with each novel training dataset sample.

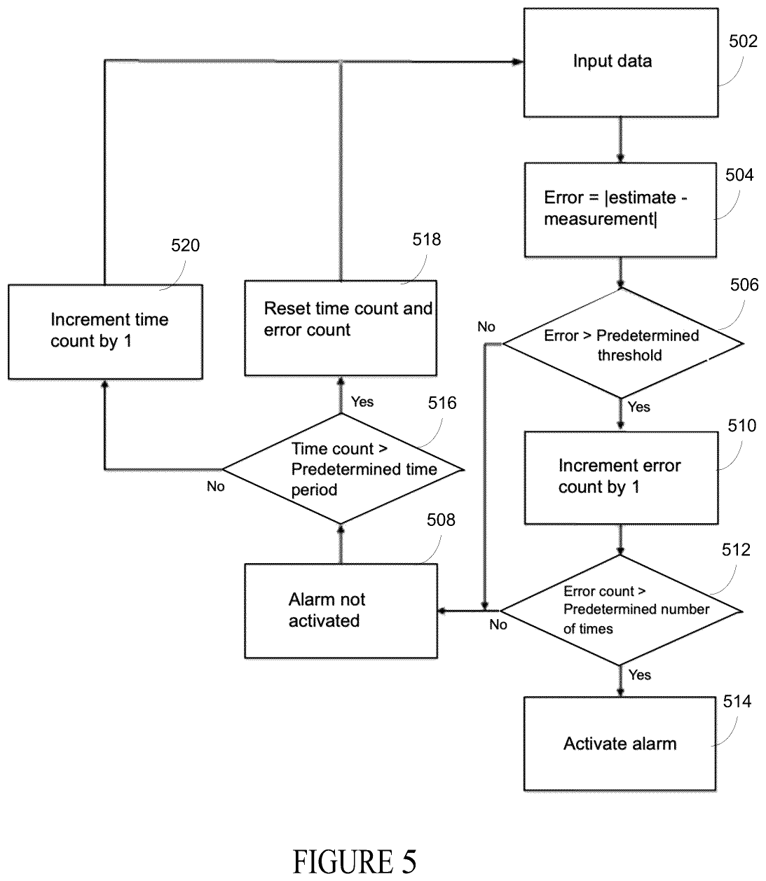

In a use case, bad data may be detected by reading data. In FIG. 5, the input data (commands in other use cases) is read from measured data at 502. If for example, the data was a voltage measurement such as a capacitor voltage 1216 and/or 1218 or a current measurement 1216 and/or 1218 such as an arm current, for example, each measurement is compared to an expected measurements by a difference operation, such as the operation shown at 504. If the difference is not greater than a predetermined threshold at 506, an alarm 1236 is not activated at 508. When the difference is greater than a predetermined threshold, an error count is incremented at 510. If the error count is greater than a second predetermined threshold at 512, the alarm 1236 is activated at 514. An alarm comprises an aural or visual signal or message (such as a short text message or electronic notification) sent in response to an event alerting the recipient user or recipient system to a system condition that may include information.

When the error count is not greater than a second predetermined threshold at 512 in FIG. 5, the alarm 1236 is not activated at 508, and a temporal count is compared to a predetermined time period at 516. When the temporal count exceeds the predetermined time count, the time count and error count is reset at 518 and the process inputs data 502. When the temporal count does not exceed the predetermined time count at 516, the time count is incremented at 520 and the process inputs data 502.

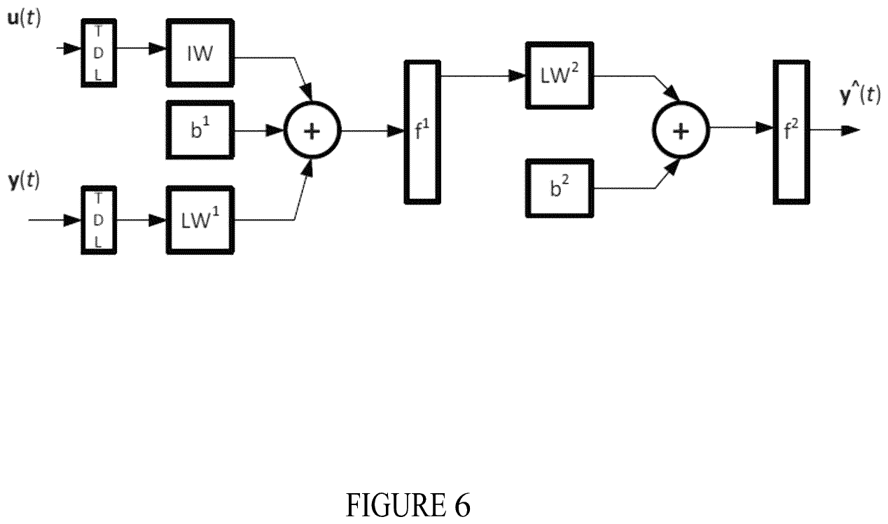

To predict arm currents and/or capacitor voltages in an autonomous reconfigurable system, a recurrent dynamic network such as a model based on autoregressive network with exogenous inputs is used in some systems. In a use case, arm currents and capacitor voltages are predicted using a nonlinear autoregressive network with an exogenous inputs model. The nonlinear autoregressive network with exogenous inputs model comprises a recurrent neural network that uses a current timestep as well as previous timestep inputs and previous timestep outputs to determine next time-step output. The model uses a combination of a hidden layer and output layer to identify the output. Each layer incorporates multiple neurons that use the sum of incoming weighted normalized data and passes it through an activation function to generate the output data from the neuron. An exemplary model with two layers is shown in FIG. 6. The model is a series-parallel architecture, with inputs and measured outputs being sourced in as inputs to the model. The outcome of the model is the predicted output in the next time-step.

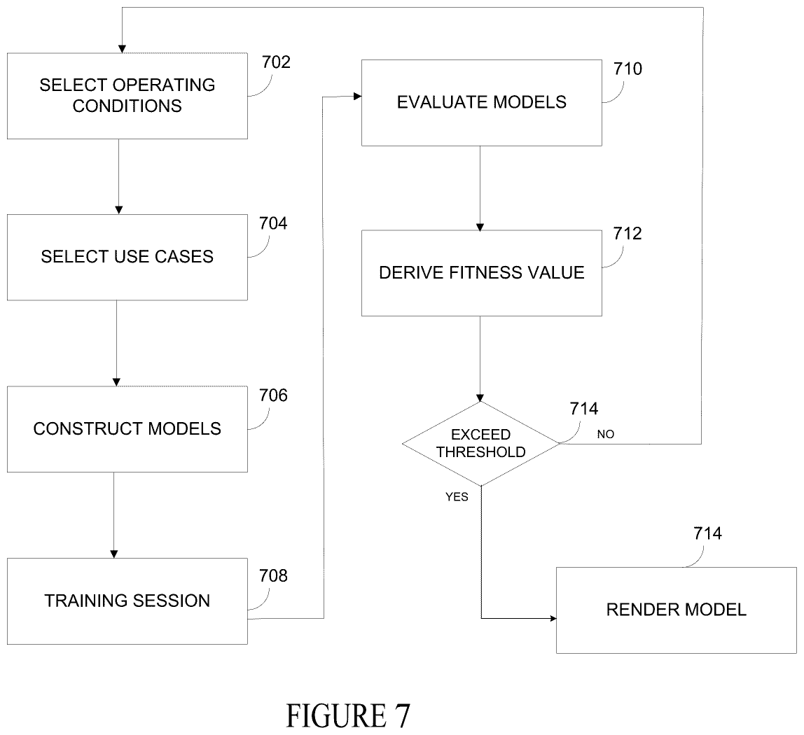

A process flow for constructing an artificial intelligence model and its exemplary evaluation by a training engine 1224 is shown via FIGS. 7 and 12. When a request is received for a trained artificial intelligence model, operating parameters representing electric grid operating conditions, power management use cases, and/or other characteristics are selected at 702 and 704 by a training engine 1224 and stored in a memory 1242. The operating conditions may include different alternating current and direct current active power dispatch commands that inherently incorporate different photovoltaic operating conditions, energy storage system operating conditions, and/or types of data, etc.

The requesting training engine 1224 then constructs one or more neural network models at 706 that detect cyber intrusions and trains one, two or more models 708 (referred to as a model) such as one two or more neural networks using learning data representations or a training dataset stored in memory 1242 and/or a remotely accessible memory based on the operating conditions and use cases.

In some alternative use cases, the training data represents the operating conditions that directly precede the effects of a cyber intrusion such as the operating state conditions that directly precede the effects of the injections or executions of unauthorized commands, receipt or processing modified data or bad data, etc. By detecting the operating systems' conditions that precede the effects of a cyber intrusion and/or the effects processing bad data, the system may shut down or isolate some or all of its at risk components before the cyber threat commands or bad data cause the system to become unstable, its code or portions of its hardware to become unstable, and/or cause the system operate in an unintended and/or unauthorized manner. In some alternative systems, the detection of cyber threats and/or bad data may automatically initiate customized operating processes recited in potential crash profiles stored in memory 1242 that mitigate the cyber threat and/or bad data threat before its affects occur making the system resistant to the undesired effects of the cyber intrusions and/or bad data. The operating policies may be enforced based on the monitored device's behavior of the systems, or based on one or more particular users' (e.g., a device and/or person) behavior. In a use cases, the behavior precedes device failures and the effect of the cyber intrusion or the processing of bad data.

Training may occur through a fixed number of iterations, a predetermined amount of time, and/or repeatedly until the constructed model hits and/or reaches a fitness threshold during a training session at 708. Some engines 708 train by iteratively reading a training dataset set a predetermined number of times while iterative tuning and/or modifying the model's configuration (e.g., the models' topology such as changing a circuit or functional blocks interconnections with other functional blocks or circuits). At 710, the trained model/models are evaluated by the training engine 1224 by processing an evaluation dataset that is separate from and different from the training dataset. Based on the trained models' performance, the training evaluation engine calculates a fitness value or an average fitness value at 712 or a plurality of fitness values when multiple models are evaluated. In some use cases, a user or an application defines the evaluation or fitness function that training evaluation engine executes. When the threshold is exceeded the model(s) at 714 are rendered as trained model(s). When it/they do not exceed the fitness value, the training session repeats 702.

When a nonlinear autoregressive network with exogenous inputs model 1226 is used to correlate variables, such as arm currents and capacitor voltages across the modules (ΣV_{cap}, Σ|ΔV_{cap}|) to alternating current-side voltages and internal control signals (modulation indices), for example, large sized models are rendered in some use cases. As the number of inputs and outputs increase, an exponential rise in the number of neurons and synapses are generated. To avoid the exponential rise in the size of some neural networks, such as the networks implemented with nonlinear autoregressive networks with exogenous inputs models 1226, the input-output combinations are split in some use cases and optimized to generate smaller sized multiple of neural networks including those executing nonlinear autoregressive network with exogenous inputs models. That is, instead of correlating variables directly, such as alternating current-side voltages and internal control signals to arm currents and voltages using a single neural network executing a nonlinear autoregressive network with exogenous inputs model in this exemplary use case, multiple neural networks executing nonlinear autoregressive networks with exogenous inputs models (e.g., ten or more) are developed to correlate the inputs to the outputs that predict the states in the autonomous reconfigurable system. For example, each phase modulation index (mj, j∈a, b, c) and the corresponding alternating current-side voltage are processed to generate the predicted alternating current-side current of the phase. Similarly, each arm's modulation index (mx, j, j∈a, b, c, x∈p, n) and the corresponding arm current are processed to generate the predicted voltages (ΣV_{cap}, Σ|ΔV_{cap}|) of the corresponding arm. And, each phase's circulating modulation indices are processed to generate the predicted circulating currents.

In a use case, estimates of the arm currents and/or voltages from a neural network executing a nonlinear autoregressive network with exogenous inputs models are compared to the measured values by the process of FIG. 5 to detect bad data. When the measured values exceeded the pre-set threshold a certain pre-defined number of times in a pre-defined period, an alarm issues that indicates a detected intrusion. In this use case, “preset threshold,” “predetermined number of time,” and “predetermined time periods” variables expressed in FIG. 5 are defined by and vary with the power grid's requirements.

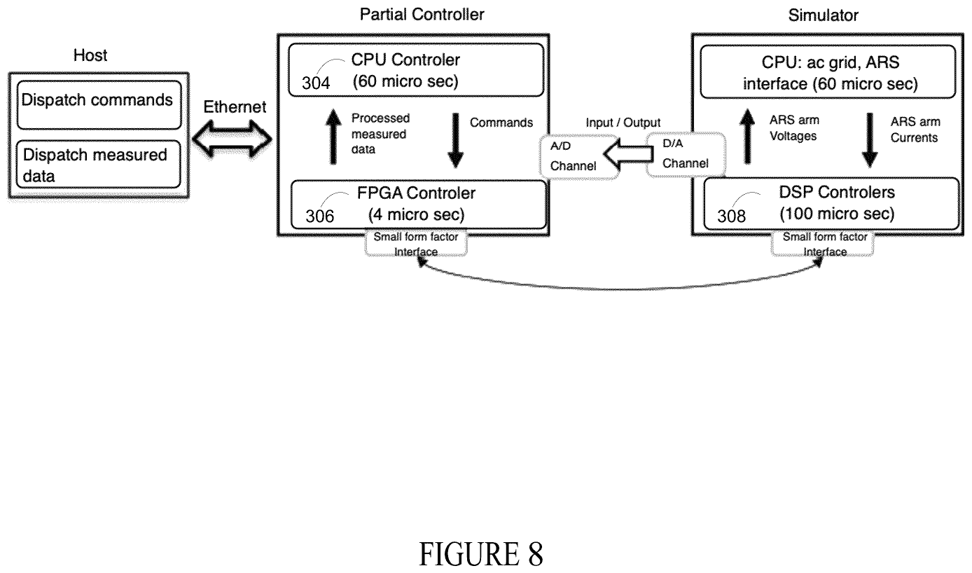

In another use case, the autonomous reconfigurable system was evaluated in simulations and hardware-in-the-loop tests. The simulations and hardware-in-the-loop test setup shown in FIG. 8 includes the integrated control system (distributed between the partial controller and simulator 1228) that incorporates the CPU controller 304 with the bad data and bad command detection algorithms (402 and 404) stored in memory and accessible to the CPU controller 304 and the FPGA controller 306. The real-time simulation model utilizes the switched system model and incorporates an emulation of the DSP controllers 308.

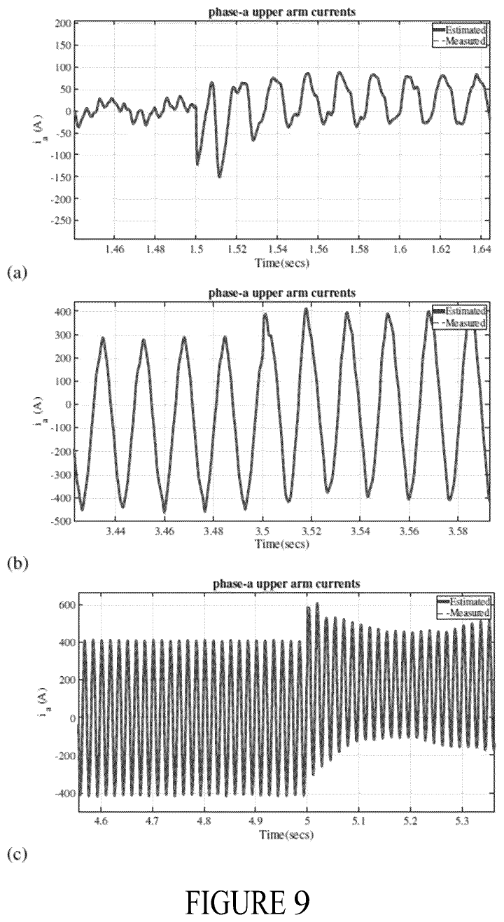

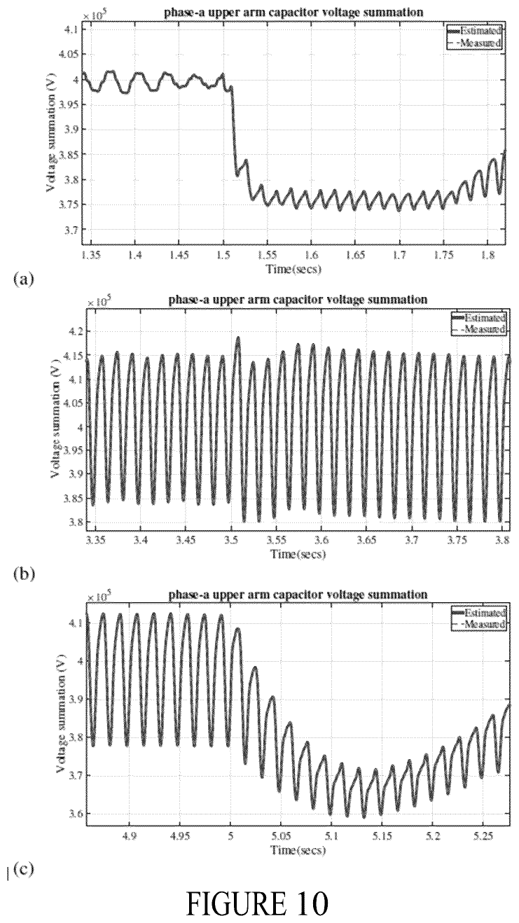

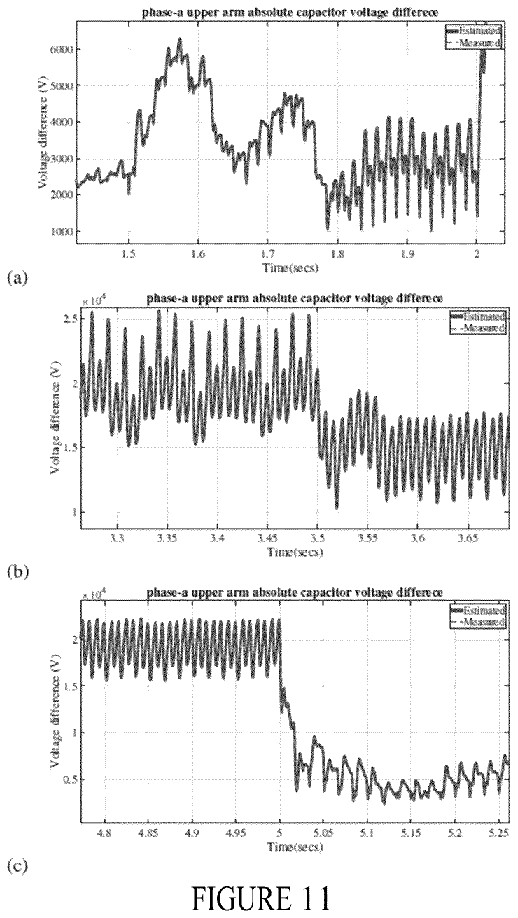

The simulator 1226 developed models, predict arm currents and voltages that are evaluated under different operating conditions. The operating conditions are based on changes to the commanded alternating current-side power, direct current-side power, photovoltaic power, and energy storage systems power. The operating conditions differ from the operating conditions used to train the models. Additionally, the prediction of the arm currents and voltages by the models were evaluated under abnormal operating conditions that would be caused by failure events in the power grid like alternating current-side transmission line faults and the loss of power generators. The phase arm current, summation of submodule capacitor voltages (ΣV_{cap}), and summation of absolute value of the difference between the submodule capacitor voltage (Σ|ΔV_{cap}|) from models (used for predictions) and from measured electromagnetic transient model simulations are plotted in FIGS. 9-11.

Under simulated (1) channel faults, (2) command modifications, (3) system losses, and (4) normal operations the autonomous reconfigurable system was monitored. Under each simulated condition, the detection algorithms and models were evaluated to measure their effectiveness in detecting bad commands and bad data. The tests showed that the cyber security intrusion detection system and its detection algorithm were effective in detecting bad commands and data.

FIG. 12 is block diagram of the systems that execute the process flows, functions, and the systems described herein and those shown in FIGS. 1-11. The system comprises a central processing unit controller 304, a field programmable gate array controller 306, and multiple (e.g., three or more) digital signal processor controllers 308, a non-transitory machine-readable medium such as a memory and/or a cloud services 1242 (the contents of which are accessible to the central processing unit controller 304, the field programmable gate array controller 306, and/or the plurality of digital signal processor controllers 308), one or more wireless/wired interfaces 1240, a network bus 1244, a data aggregator 310, and source sensors 1236. The non-transitory machine-readable medium encoded with machine-executable instructions executed by one or more controllers 304, 306, and/or 308 causes the system to render some or all of the functionality associated with the autonomous reconfigurable system described herein. The memory and/or cloud services 1242 store control circulating current control (e.g., alternating current and/or direct current) 1202, synchronous generator emulation function 1204 or virtual synchronous generator, energy balancing 1206, the maximum available photovoltaic power (Pₚᵥ₋ₘₚₚₜ 1208), the state-of-charge 1210, the power control 1212 that controls the transformation, transportation, and distribution of electrical energy, the capacitor voltage balancing 1214, capacitor voltage 1216 and/or 1218 or a current measurement 1216 and/or 1218, processing power quality functions 1220, power quality functions 1222, a training engine 1224, optional external application and/or devices 1238, nonlinear autoregressive networks with exogenous inputs models 1226, simulator 1228, bad data command detection algorithm 402 and/or bad command detection algorithms 404. The term cloud and cloud system is intended to broadly encompass hardware and software that enables the systems and processes executed and data to be maintained, managed, and backed up remotely and made available to users over a network. In this system, clouds and/or cloud storage provides ubiquitous access to the system's resources that can be rapidly provisioned over a public and/or a private network at any location. Clouds and/or cloud storage allows for the sharing of resources, features, and utilities in any location to achieve coherence services.

The cloud/cloud services or memory 1242 and/or storage disclosed also retain an ordered listing of executable instructions for implementing the processes, system functions, and features described above in a non-transitory machine or computer readable code. The machine-readable medium may selectively be, but not limited to, an electronic, a magnetic, an optical, an electromagnetic, an infrared, or a semiconductor medium. A non-exhaustive list of examples of a machine-readable medium includes: a portable magnetic or optical disk, a volatile memory, such as a Random-Access Memory (RAM), a Read-Only Memory (ROM), an Erasable Programmable Read-Only Memory (EPROM) or a Flash memory, or a database management system. The cloud/cloud services and/or memory 1242 may comprise a single device or multiple devices that may be disposed on one or more dedicated memory devices or disposed within one or more of the controllers 304, 306, and/or 308, customized circuit or other similar device. When functions, steps, etc. are “responsive to” or occur “in response to” another function or step, etc., the functions or steps necessarily occur as a result of another function or step, etc. A device or process that is responsive to another requires more than an action (i.e., the process and/or device's response to) merely follow another action.

The term “engine” refers to a processor or a portion of a program that determines how the programmed device manages and manipulates data. For example, a training engine 1224 includes the tools for forming and training artificial intelligence and/or neural networks. The term “substantially” or “about” encompasses a range that is largely in some instances, but not necessarily wholly, that which is specified. It encompasses all but a significant amount, such as what is specified or within five to ten percent. In other words, the terms “substantially” or “about” means equal to or at or within five to ten percent of the expressed value. Forms of the term “cascade” and the term itself refer to an arrangement of two or more components including circuits such that the output of one circuit is the direct input of the next circuit (e.g., in a series connection). The term “real-time” and “real time” refer to responding to an event as a detection occurs, such as making corrections or changing power supply/source configurations in response to measurements as they are made or commands as they are received. A real time operation are those operations which match external activities and proceed at the same rate (e.g., without delay) or faster than that rate of the external activities and/or an external process. Some real-time autonomous reconfigurable systems operate at a faster rate as the physical element it is controlling. The term communication, in communication with, and versions of the term are intended to broadly encompass both direct and indirect communication connections.

The autonomous reconfigurable systems disclosed herein may be practiced in the absence of any disclosed or expressed element (including the hardware, the software, and/or the functionality expressed), and in the absence of some or all of the described functions association with a process step or component or structure that are expressly described. The systems may operate in the absence of one or more of these components, process steps, elements and/or any subset of the expressed functions.

Further, the various elements and autonomous reconfigurable system components, and process steps described in each of the many systems and processes described herein is regarded as divisible with regard to the individual elements described, rather than inseparable as a whole. In other words, alternate autonomous reconfigurable systems encompass any variation and combinations of elements, components, and process steps described herein and may be made, used, or executed without the various elements described (e.g., they may operate in the absence of) including some and all of those disclosed in the prior art but not expressed in the disclosure herein. Thus, some systems do not include those disclosed in the prior art including those not described herein and thus are described as not being part of those systems and/or components and thus rendering alternative systems that may be claimed as systems and/or methods excluding those elements and/or steps.

The autonomous reconfigurable system improves the responsiveness of power producers and power distributors. The systems increase the reliability of the power grid and reduce power deficits because they increase the capacity of the power grid beyond its conventional sources. The systems also serve as a power reserve for unexpected demands. The systems' hierarchical controller monitors aggregate power flow through the power grid in real time, allowing the systems and its operators to ensure a constant and consistent power grid-flow that meets consumer's changing demand. The controllers that comprise the system's hierarchical controller monitor each branch of the autonomous reconfigurable system that sources the power grid and automatically shift and/or provide electricity supply to high demand areas when it is needed in real time. Moreover, the disclosed technology mitigates the threat of cyber intrusions by monitoring commands including the commands its receives from the system operators and the data processed by the hierarchical controller through artificial intelligence.

Other systems, methods, features and advantages will be, or will become, apparent to one with skill in the art upon examination of the figures and detailed description. It is intended that all such additional systems, methods, features, and advantages be included within this description, be within the scope of the disclosure, and be protected by the following claims.

1. An autonomous reconfigurable system, comprising:
a plurality of arms comprising a plurality of submodules connected in series terminating at a plurality of inductors that form a three-port circuit at a common node and that sources a direct current voltage output and an alternating current voltage output;
a photovoltaic submodule sourcing a portion of the direct current voltage output and the alternating current voltage output;
an energy storage system submodule connected in series to the photovoltaic submodule and sourcing a second portion of the direct current voltage output and the alternating current voltage output;
a submodule connected in series to the energy storage system submodule and sourcing a third portion of the direct current voltage output and the alternating current voltage output;
a plurality of modular converters configured in a half-bridge topology;
where a first modular converter directly couples an output of the photovoltaic submodule, a second modular converter directly couples an output of the energy storage system submodule, and a third modular converter directly couples the submodule in each arm of the plurality of arms; and
where a plurality of first modular converters, a plurality of second modular converters, and a plurality of third modular converters generate a medium grid utility voltage or a high grid utility voltage.

2. The autonomous reconfigurable system of claim 1 further comprising a non-isolated converter directly connected to the second modular converter in series.

3. The autonomous reconfigurable system of claim 2 where the non-isolated converter is transformerless and comprises a plurality of silicon carbide metal-oxide-semiconductor field-effect transistors connected in series connected in parallel to a capacitor.

4. The autonomous reconfigurable system of claim 3 where the non-isolated converter is directly connected to a resonant circuit that generates a voltage magnification.

5. The autonomous reconfigurable system of claim 1 further comprising a multi-state converter comprising a first H-bridge sourcing an isolation transformer, the multi-state converter cascades the first modular converter.

6. The autonomous reconfigurable system of claim 5 where the isolation transformer includes a secondary that cascades a second H-bridge in a dual active bridge that sources photovoltaic power.

7. The autonomous reconfigurable system of claim 1 further comprising a plurality of digital signal processors, where each digital signal processor determines a power level generated from the photovoltaic submodule and the energy storage system submodule.

8. An autonomous reconfigurable system, comprising:
a plurality of arms terminating at a plurality of inductors that form a plurality of three-port circuits that source a direct current voltage output and an alternating current voltage output;
a photovoltaic submodule sourcing a portion of the direct current voltage output and the alternating current voltage output;
an energy storage system submodule connected in series to the photovoltaic submodule and sourcing a second portion of the direct current voltage output and the alternating current voltage output;
a submodule connected in series to the energy storage system submodule and sourcing a third portion of the direct current voltage output and the alternating current voltage output;
a central processor controller that determines a plurality of arm modulation indices and issues a plurality of reference power commands transmitted to a field programmable gate array controller;
the field programmable gate array controller in direct communication with the central processor disaggregates a plurality of variables monitored from each arm that form the plurality of three-port circuits and issues commands to the photovoltaic submodule, the energy storage system, and the submodule through a plurality of digital signal processor controllers in continuity with the plurality of arms; and
where each of the photovoltaic submodule and each of the energy storage system are separately controlled by a dedicated digital signal processor, respectively.

9. The autonomous reconfigurable system of claim 8 where the central processor controller controls the arms output as an aggregate to maintain a grid-source stability without directly controlling or communicating with the photovoltaic submodule, the energy storage system submodule, and the submodule.

10. The autonomous reconfigurable system of claim 9 where the field programmable gate array controller is programmed to balance a plurality of capacitor voltages sourced by each of the photovoltaic submodule, the energy storage system submodule, and the submodule.

11. The autonomous reconfigurable system of claim 8 where the plurality of digital signal processors control a current flow through each inductor that comprise the plurality of inductors.

12. The autonomous reconfigurable system of claim 11 where the plurality of digital signal processors generate a plurality of switching commands a dc-dc converter that interfaces the photovoltaic submodule.

13. The autonomous reconfigurable system of claim 11 where a plurality of photovoltaic submodules, a plurality of energy storage system submodules, and a plurality of submodules form the plurality of arms by a series connection of photovoltaic submodules, energy storage system submodules, and submodules.

14. The autonomous reconfigurable system of claim 11 further comprising a neural network executed by the central processing unit controller that is trained to detect a cybersecurity command threat and a bad data.

15. The autonomous reconfigurable system of claim 14 where the neural network comprises a plurality of neural networks executing nonlinear autoregressive networks with exogenous inputs models that correlate a plurality of inputs to the arms to a plurality of outputs from a plurality of submodules that predict a plurality of operating states of each of the photovoltaic submodule, the energy storage system submodule, and the submodule that is processed to detect the cybersecurity command threat and the bad data.

16. A non-transitory machine-readable medium encoded with machine-executable instructions, wherein execution of the machine-executable instructions is for:
storing a plurality of operating parameters representing a plurality of electric grid operating conditions and a plurality power management use cases in a memory by a training engine;
constructing a plurality of models based on the operating parameters representing a plurality of electric grid operating conditions and a plurality power management use cases;
training the plurality of models by iteratively modifying a plurality of configurations of the plurality of models to render a plurality of trained models in response to a processing of a training dataset;
evaluating the plurality of trained models using an evaluation data set;
rendering a plurality of fitness values based on the evaluating the plurality of trained models; where a fitness value is associated with each of a trained model that comprise the plurality of trained models; and
detecting a cyber intrusion through one or more of the trained models.

17. The non-transitory machine-readable medium of claim 16, where the machine-executable instructions used to generate a plurality of neural networks that are executed repeatedly until a predetermined number of trained neural networks have a plurality of fitness values exceed a predetermined value.

18. The non-transitory machine-readable medium of claim 16, where the operating parameters are rendered from a plurality of sensors monitoring a plurality of photovoltaic submodules, a plurality of energy storage systems, and a plurality of submodules.

19. The non-transitory machine-readable medium of claim 16, where the plurality of models comprises a plurality of nonlinear autoregressive network with exogenous inputs model.

20. The non-transitory machine-readable medium of claim 16 where the training dataset represents the operating conditions that directly precede an effect of a cyber intrusion.
